(19) United States
(12) Patent Application Publication
(10) Pub. No.: US 2008/0287114 A1
(43) Pub. Date: Nov. 20, 2008

(54) Adaptive Resource Handling for Radio Link Reconfigurations

(75) Inventor: Goran Rune, Linkoping (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/091,562

(22) PCT Filed: Oct. 27, 2006
(86) PCT No.: PCT/SE2006/050436

§ 371 Date: Apr. 25, 2008

(30) Foreign Application Priority Data
Nov. 2, 2005 (SE) 0502444-3

(51) Int. Cl. H04Q 7/20

(52) U.S. Cl. 455/418

(57) ABSTRACT

The present invention relates to a method and arrangement in a radio base station (122,133) of a telecommunication system (100) to achieve an adaptive resource handling for quasi-synchronised reconfigurations of radio bearers and transport channels. In response to a received message to prepare a synchronised radio link reconfiguration, the radio base station (122, 133) informs, e.g. in an indication message that the synchronised radio link reconfiguration is prepared, a centralised controller node (121, 131) that the radio base station admits a simultaneous supporting of an old and a new radio link configuration during a transition

### FIELD OF THE INVENTION

The present invention relates to methods and arrangements in a 3^{rd} generation telecommunication system, in particular to an adaptive resource handling for quasi-synchronised reconfigurations.

### BACKGROUND OF THE INVENTION

In a 3^{rd} generation telecommunication system, e.g. based on WCDMA technology as currently standardised in the 3GPP, it is a fundamental part that establishing, releasing, or reconfiguring of services, which implies in the Radio Access Network (RAN) a configuration change of the Radio Bearers (RB), carried on transport channels (provided by the physical layer of the radio interface), to be applied by a user equipment (UE) is performed in a synchronous manner. This also implies that all the concerned radio base station nodes (also denoted Node Bs) and the user equipments (UE) change in a synchronous manner from an “old” configuration to a “new” configuration at a certain “activation time”, which is decided by the serving radio network controller (SRNC) that is controlling said radio base stations. This “activation time” is an absolute time (within a cycle of the Connection Frame Number (CFN)) as explained, e.g., in the document 3GPP TS 25.402, “Synchronisation in UTRAN Stage 2” issued by the 3^{rd} Generation Partnership Project. The SRNC needs to take several aspects into account when deciding the “activation time”. This includes, e.g., the time that is needed to transmit a full message to a user equipment including possible message re-transmissions.

One possibility to enhance this procedure is the removal of the activation time feature, which then could be referred to as a “quasi-synchronized reconfiguration”. According to such a method, the radio base station will have to support two parallel configurations during the transition from an “old” to a “new” configuration of the Radio Bearers/transport channels. By detecting uplink synchronisation for a new configuration the base station can conclude that a user equipment has changed from the old to the new configuration. Once the uplink synchronisation has been detected the radio base station can release the resources that are related to the old configuration. The accompanying FIG. 2 shows such a quasi-synchronised reconfiguration with simultaneous transmission of two dedicated physical control channels (DPCCH). In said figure, the core network (CN) transmits a “RAB assignment request” (21) for a service to be applied by a certain user equipment (UE) whereupon the radio network controller (RNC) transmits a “synchronised radio link reconfigure prepare” (22) to the Node B. The Node B responds with a “synchronised radio link reconfigure ready” message (23) to the radio network controller. In case of an AAL2 connection, a transport bearer needs to be established 24 by Node B, RNC, and the core network. Now the radio network controller (RNC) can transmit a “radio link reconfiguration commit” message 210 to the Node B including the new timing offset and the indication to check the uplink scrambling code whereupon the Node B starts (211) to transmit the new configuration during the DTX periods of the DPDCH. The radio network controller transmits a “radio bearer setup” 212 including the activation time and the new timing offset to the user equipment (UE). The user equipment (UE) applies the new configuration 213 and performs synchronisation. The Node B stops to transmit the old configuration 214 during the DTX periods and applies the new downlink and uplink configuration 215. The Node B transmits a “radio link restore” message 216 to the radio network controller (RNC) while the user equipment (UE) transmits a “reconfiguration complete” message 217 to the radio network controller (RNC) whereupon the radio network controller (RNC) transmits a “RAB assignment response” 218 to the core network (CN).

### BRIEF DESCRIPTION OF THE DRAWINGS

FIG. 1 illustrates a UMTS terrestrial radio access network (UTRAN) as defined in the third generation mobile communications standard 3GPP.

FIG. 2 shows an enhanced quasi-synchronised reconfiguration method with simultaneous transmission of two DPCCHs.

FIGS. 3a and 3b illustrate the “radio link reconfiguration ready” message to be transmitted to the radio network controller and including an indication whether the quasi-synchronised reconfiguration can be applied or not.

FIG. 4 illustrates a base station including the arrangement according to the present invention.

### DETAILED DESCRIPTION OF THE INVENTION

It has been observed that the method as depicted above implies the drawback that a base station needs to reserve resources for both the old and the new configuration of radio bearers/transport channels during a period of time. A double allocation of base station resources is thus needed from the point in time when the base station has allocated the resources for a new configuration until the point in time when an uplink synchronisation has been detected for the new configuration.

It is therefore an object of the present invention to achieve a less resource demanding method for quasi-synchronised reconfiguration than the one described above and to achieve an arrangement providing the necessary means to conduct said method.

For a radio base station that needs to provide two parallel configurations of radio bearers/transport channels during a transition from an old to a new configuration, e.g. due to a service establishment, reconfiguration, or release, it is the basic idea of the present invention to let the base station inform the SRNC whether or not a “quasi-synchronized reconfiguration” can be used for a particular reconfiguration of radio bearers/transport channels. This can be used to avoid a double allocation of base station resources in those situations where these resources are not available.

It is one advantage of the present invention that a “quasi-synchronised reconfiguration” as depicted above can be exploited without the disadvantage of sacrificing capacity, e.g., in terms of the number of user equipments or radio bearers/transport channels that the base station can support or in terms of the achievable data throughput.

It is a further advantage of the present invention that it is possible to make a trade-off either in favour of a fast radio bearer set-up, reconfiguration, or release whenever possible, or in favour of capacity whenever necessary.

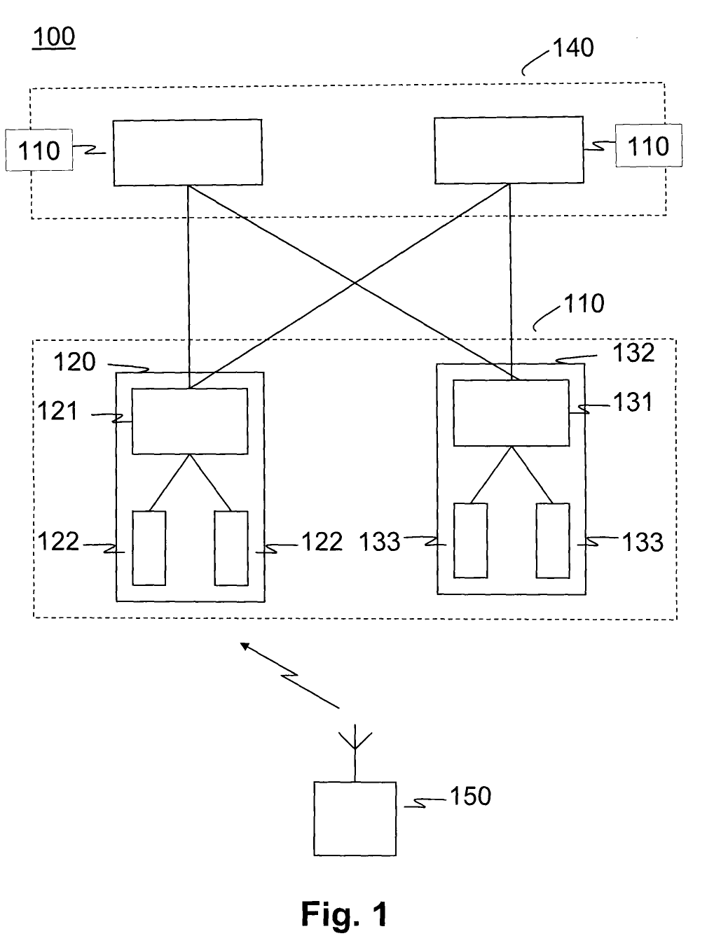

FIG. 1 illustrates a UMTS terrestrial radio access network (UTRAN) as defined in the third generation mobile communications standard 3GPP. As shown in FIG. 1, the UTRAN 110 includes one or more radio network sub-systems (RNSs) 120 and 130. Each RNS 120,130 includes Radio Network Controller (RNC) 121, 131 and one or more Node Bs 122, 123, 132, 133 (the Node B is similar to a radio base station). For example, Node B 122 is managed by RNC 121, and receives information transmitted from the physical layer of the user equipment (UE) 150 (sometimes called a mobile terminal) through an uplink channel and transmits a data to the UE 150 through a downlink channel. The Node B acts as an access point of the UTRAN from the UE's point of view. The RNCs 121 and 131 allocate and manage radio resources of the UMTS and are connected to a suitable the core network depending on types of services provided to users. For example, the RNCs 121 and 131 are connected to a mobile switching centre (MSC) 141 for a circuit-switched communication, such as a voice call service, and are connected to a Serving GPRS Support Node (SGSN) 142 for packet switched communication such as a wireless Internet service. The RNC in charge of a direct management of the Node B is called a Control RNC (CRNC). The CRNC manages common radio resources. On the other hand, the RNC that manages dedicated radio resources for a specific UE is called a Serving RNC (SRNC). The CRNC and the SRNC can be co-located in the same physical node. However, if the UE has been moved to an area of a new RNC that is different from SRNC, the CRNC and the SRNC may be located at physically different places. The UMTS includes interfaces that operate as a communication path between various network elements. For example, the interface between a Node B and a RNC is called an Iub interface, and the interface between RNCs is called an Iur interface. The interface between the RNC and the core network is called an Iu interface.

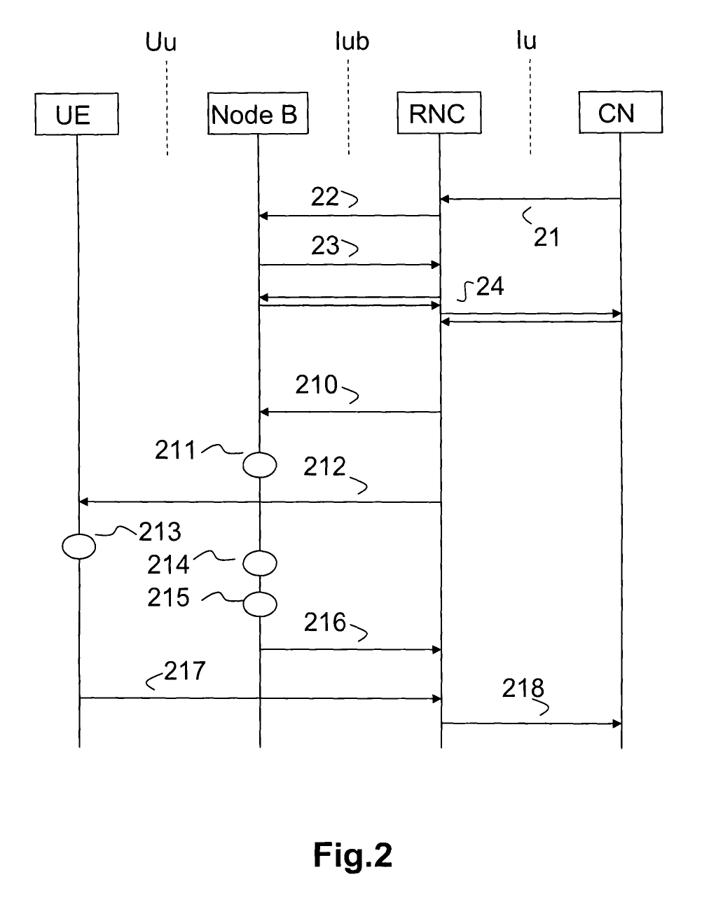

The solution according to the present invention, i.e. to let the base station indicate to the SRNC whether or not a “quasi-synchronized reconfiguration” can be applied for a specific reconfiguration can be illustrated by help of FIG. 2 where the base station can provide this indication to the SRNC. This indication can be provided to the radio network controller in one of the messages transmitted to the radio network controller between the reception of the “synchronised radio link configure prepare” message 22 and the “radio bearer setup message” 212. In a preferred embodiment of the present invention, the indication is included, e.g. as a data field, in the message “Synchronised Radio Link Reconfigure Ready” 23. The indication provided to the SRNC should at least allow distinguishing the following possible “values”, which the base station can freely select for indicating a specific reconfiguration:

(a) a quasi-synchronized reconfiguration can be applied;

(b) a quasi-synchronized reconfiguration can not be applied.

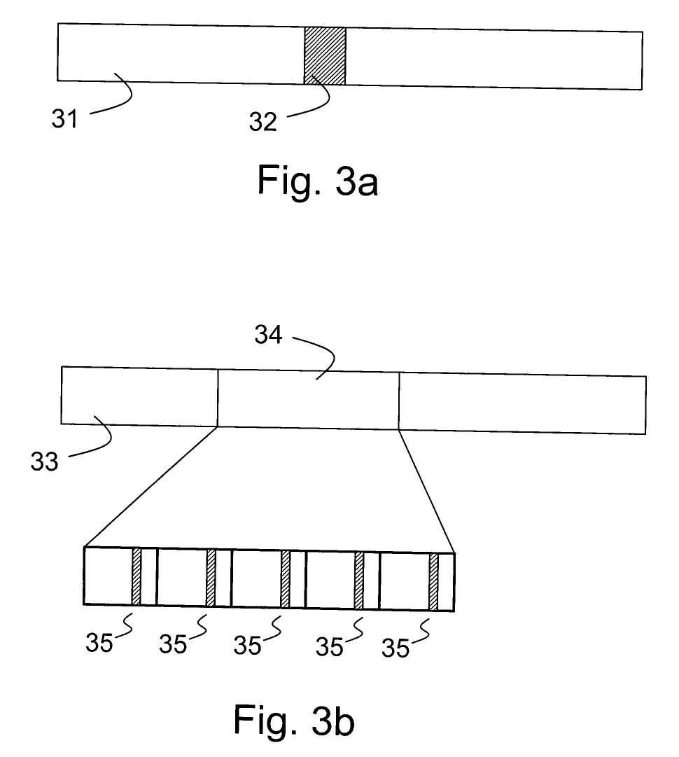

FIG. 3a illustrates the “radio link reconfiguration ready” message 31 mentioned above and including a data field 32 according to the present invention. Here, as an example, the data field is included in form of a one-bit field indicating the quasi-synchronised reconfiguration status, i.e. whether or not the base station admits quasi-synchronised reconfiguration. For instance, a value 0 can be set if quasi-synchronised reconfiguration can not be applied while a value 1 indicates that quasi-synchronised reconfiguration can be applied. While FIG. 3a illustrates an example where it is only possible to set the quasi-synchronised reconfiguration status for all concerned radio bearers or transport channels FIG. 3b illustrates a conceivable alternative of a message format where, depending on the applied radio technology, the “radio link reconfiguration ready” message 33 includes a section 34 comprising a list of N radio bearers or transport channels whereby a data field 35 as described above is applied in each sub-section relating to one of the N radio bearers or transport channels.

The base station can, for instance, set the value to “quasi-synchronized reconfiguration can not be applied” in (at least) the following cases: One conceivable scenario is that there no spare resources are available to decode both the old and the new configuration at the same time. Another conceivable scenario is that there are almost no spare resources available to decode both the old and the new configuration at the same time (i.e. in order to create a safety margin for other reasons to allocate resources in the base station). Yet another scenario might be that the radio base station does not support “reconfiguration without activation time”.

The present invention allows a trade-off either in favour of a fast set-up, release, or re-configuration of radio bearers or in favour of capacity, e.g., in terms of the number of user equipments or radio bearers/transport channels that can be supported by the base station or the achievable data throughput. One conceivable embodiment of the present invention could be to implement, e.g., a threshold value that either constitutes a fixed value or can be dynamically changed by the base station with regard to certain parameters that are observed or controlled by the base station. For instance, when informing the Radio Network controller whether or not the base station can support a quasi-synchronised reconfiguration of radio bearers/transport channels and the number of supported radio bearers/transport channels exceeds said threshold, the base station may take a decision more in favour of a maximised number of supported radio bearers/transport channels while, if said number remains below said threshold, the base station rather can take a decision in favour of a fast reconfiguration of radio bearers/transport channels.

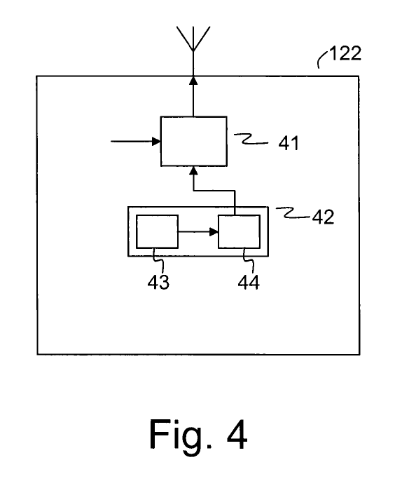

FIG. 4 illustrates a radio base station 122 including the arrangement according to the present invention. The information element indicating whether or not the base station supports a quasi-synchronised reconfiguration is generated by a generating means 41. For instance, said means generate a value as explained above that is included in an appropriate message sent from the base station to the radio network controller, e.g. the message indicating that the synchronised radio link reconfiguration is ready. In order to make the decision whether or not to support quasi-synchronised reconfiguration the base station can apply an admission means including a storing means 43 for maintaining a threshold value and a means 44 for calculating the difference between said threshold value and the number of radio bearers/transport channels that are currently supported by the base station. As explained above, the base station can make its decision by help of the determined difference.

While the invention has been described in connection with what is presently considered to be the most practical and preferred embodiment, it is to be understood that the invention is not to be limited to the disclosed embodiment but is intended to also cover various modifications and equivalent arrangements included within the scope of the appended claims.

1. A method in a radio base station of a telecommunication system for reconfiguration of radio bearers and their corresponding transport channels between a radio network controller and a user equipment, said system comprising a connection to one or more centralized controller nodes and supporting one or more user equipments, said method comprising the steps of:
informing, in response to a received message to prepare a synchronized radio link reconfiguration, a centralized controller node that the radio base station admits a simultaneous support of an old and a new radio link configuration during a transition period of time.

2. The method according to claim 1, wherein said step of informing the centralized controller node comprises setting an information element flag to be included in the indication message that the synchronized radio link reconfiguration is prepared.

3. The method according to claim 1, whereby wherein said step of informing the centralized controller node is valid for all radio bearers that shall be reconfigured and their corresponding transport channels.

4. The method according to claim 1, wherein said step of informing the centralized controller node is performed separately for each radio bearer that shall be reconfigured and their corresponding transport channels.

5. The method according to claim 2, wherein said information element constitutes a one-bit data field.

6. The method according to claim 2, wherein said information element constitutes a data field with two or more bits.

7. The method according to claim 1, further comprising the step of admitting a simultaneous support of an old and a new radio link configuration only if the number of radio bearers or transport channels currently supported by the base station remains below a certain threshold value.

8. The method according to claim 7, wherein said threshold value is static.

9. The method according to claim 7, wherein said threshold value is dynamically adjusted by the base station in response to one or several parameters.

10. The method according to claim 1, further comprising the step of not admitting a simultaneous support of an old and a new radio link configuration if the base station cannot provide sufficient resources.

11. A radio base station in a telecommunication system, comprising a connection to one or more centralized controller nodes and supporting one or more user equipments, characterised in a generating means for generating an information element in a message to a centralized controller node to inform said centralized controller node that the radio base station admits simultaneous support of an old and a new radio link configuration during a transition period of time.

12. The radio base station according to claim 11, wherein said generating means are arranged to generate a value in said information element indicating said simultaneous support, and arranged to include said information element in the message for indicating that the synchronized radio link reconfiguration is prepared.

13. The radio base station according to claim 12, further comprising an admission means for simultaneous support of an old and a new radio link configuration, said means including a storing means for maintaining a threshold value and a means for calculating a capacity measure such as to determine the value in said generated information element.

14. The method according to claim 13, wherein said capacity measure denotes the difference between said threshold value and the number of radio bearers or transport channels currently supported by the base station.

15. The radio base station according to claim 13, wherein said storing means includes an adaptive threshold value.
